(19) United States
(12) Patent Application Publication
(10) Pub. No.: US 2026/0165258 A1
(43) Pub. Date: Jun. 18, 2026

(54) GREENING SYSTEM AND METHOD OF INSTALLING THE SAME

(71) Applicant: KAWADA INDUSTRIES, INC., Tokyo (JP)

(72) Inventor: Shinichi KAWADA, Tokyo (JP)

(73) Assignee: KAWADA INDUSTRIES, INC., Tokyo (JP)

(21) Appl. No.: 18/710,525

(22) PCT Filed: Nov. 19, 2021
(86) PCT No.: PCT/JP2021/042568

§ 371 Date: May 15, 2024

(51) Int. Cl. A01G 9/033; A01G 9/02; A01G 27/02

(52) U.S. Cl. CPC A01G 9/033; A01G 9/026; A01G 9/027; A01G 9/028; A01G 27/02

(57) ABSTRACT

A greening system includes a soil layer, a permeable soil layer supporting portion supporting the soil layer, and a planar water container portion supporting the soil layer and the soil layer supporting portion and has a water storage portion and an air layer above the water storage portion, in which the water container portion is configured to have the water storage portion by forming a container unit into an approximately rectangular shape in the top surface view and mating the sides of the adjacent container units to have the water storage portion. The container unit has at least two container-shaped portions connected to each other that can each be a water container and are arranged without overlapping each other. The container unit has an overflow portion through which water can overflow into the adjacent container-shaped portion, into the adjacent container unit, and to the outside of the container unit, respectively.

### TECHNICAL FIELD

This invention relates to a greening system comprising a container that provides a water storage portion between an installation surface where the greening system is installed and a soil layer where plants are planted, particularly to a greening system that can prevent the heat death of plants and has excellent load bearing capability, and a method of installing thereof.

### BACKGROUND ART

As a method for maintaining appropriate moist conditions for growing plants, there has been used a method of growing plants by installing a water storage portion using a non-permeable plastic sheet below a growing layer (refer to Patent Literature 1 on growing lawn grass, for example).

As a method for preventing the heat death of plants, there have been used a roof greening structure (refer to Patent Literature 2, for example) where an air layer is provided by installing a planter-like unit or planter between a non-flat roof and a soil layer, and an insulation block (refer to Patent Literature 3 for example) that can grow plants and is provided with legs for forming an air layer.

Also, a green roof with excellent waterproofing and heat insulation properties has been used, in which corrugated plates of different heights are placed on top of each other on a support member that forms the framework of the roof to form a prismatic air layer between the lower and upper corrugated plates and a water storage portion with a weir in the recess of the upper corrugated plate is formed (refer to Patent Literature 4, for example).

Patent Literature 5 discloses a greening system for growing plants comprising a soil layer for planting plants, a permeable soil layer supporting portion for supporting the soil layer, and a water container portion having a water storage portion and an air layer below the water storage portion for supporting the soil layer and the soil layer supporting portion, in which the water container portion has at least two stacked container units to form an air layer between the container units and the topmost container unit constitutes the water storage portion and the container units have at least two container-shaped portions connected to each other, each of which can be a water container.

### CITATION LIST

### Patent Literature

Patent Literature 1: JP-A-H11-75531

Patent Literature 2: JP-A-2004-137895

Patent Literature 3: JP-A-2003-147873

Patent Literature 4: JP-A-2001-16982

Patent Literature 5: Japanese U.S. Pat. No. 5,017,591

### SUMMARY OF INVENTION

### Technical Problem

The method disclosed in Patent Literature 1 involves installing only the water storage portion without providing an air layer and requires forming the insulation layer by using insulation material to prevent heat death of plants caused by heat from below. The methods disclosed in Patent Literatures 2 and 3 each involve forming the air layer by using the planter-like unit or the like on the non-flat roof and need to produce the planter-like unit that fits the shape of each roof, causing significant efforts in laying the insulation block used for forming the air layer. In the method disclosed in Patent Literature 4 using corrugated plates on the greening roof, it is necessary to process multiple weirs on the plates to form the water storage portion. It is also necessary to cover the open ends of the air layer or the like. Moreover, the upper plate and the lower plate need fixing with a bolt or the like during installation, which needs a complicated process. With such a configuration that corrugated plates are placed on top of each other, it is difficult to process the plates so as to fit the size and shape of the area where the greening system is to be installed, particularly to process the air layer and water storage portion at the end part of the installation site.

The method disclosed in Patent Literature 5 involves stacking two container units on top of each other in the water container portion, causing a problem of consuming effort for the installation. Also, when container units of the same shape are stacked on top of each other, creaking is caused at the overlapping part due to the load from the top. Producing container units of different shapes to be used for the upper part and lower part, to solve this problem, causes another problem of cost increase.

This invention is made in view of the above problems, and the object thereof is to provide, using a container unit that is easy to process, a greening system that is easy to construct and is excellent in waterproof properties, water retention ability, heat-insulating properties, and load bearing, and a method of installing the greening system.

### Solution to Problem

A greening system of the present invention that advantageously solves the above problems is the greening system for growing plants comprising
a soil layer for planting plants,
a permeable soil layer supporting portion that supports the soil layer, and
a planar water container portion that supports the soil layer and the soil layer supporting portion and is provided with a water storage portion and an air layer above the water storage portion,
in which
the water container portion is configured to have the water storage portion by forming a container unit into an approximately rectangular shape in the top surface view and mating the sides of the adjacent container units so as to have the water storage portion;
the container unit has at least two container-shaped portions connected to each other that can each be a water container and are arranged without overlapping each other; and
the container unit has, at each predetermined position, an overflow portion through which water can overflow into the adjacent container-shaped portion, into the adjacent container unit, and to the outside of the container unit, respectively.

The greening system for growing plants of the present invention is considered to have preferable solution as follow:
(a) the container unit is provided with, at a predetermined position, a reinforced portion connecting the adjacent container-shaped portions;
(b) the container unit is mountain-folded, i.e., folded into an inverted V shape on two outer sides and valley-folded, i.e., folded into a V shape on the other two sides, in which the mountain-folded sides are each divided by a notch and have a fixed portion with a hook at the leading end, while the valley-folded sides each have a hole for the hook to engage when the sides are mated;
(c) the container unit is configured to have a groove at the top center of each of two of the four side walls forming the container-shaped portion that serves as an overflow portion, allowing water from all of the container-shaped portions in the container unit to overflow to the outside of the container unit;
(d) the overflow portion provided between the adjacent container units has one groove-shaped projection formed per container unit so that the groove-shaped projection mates to another overflow portion of another container unit;
(e) the container unit is formed by injection-molding molten thermoplastic resin into a mold at high pressure; and
(f) the soil layer supporting portion is a resin net with a yield point strength of not less than 2000 N/m.

The method of installing a greening system according to the invention that advantageously solves the above problems is a method of installing any of the above greening systems, in which the sides of the adjacent container units are mated to each other to render the container unit a water storage portion, the water container portion is configured such that the upper part of the container unit corresponding to the overflow portion is to be an air layer, the soil layer supporting portion is arranged so as to be supported by the water container portion, and the soil layer supported by the soil layer supporting portion is arranged.

The method of installing a greening system according to the invention is considered to have the following preferable solution.
(g) the overflow portion provided between the adjacent container units has one groove-shaped projection per container unit so that the groove-shaped projection is arranged to mate to another overflow portion of another container unit.

### Advantageous Effects of Invention

As described above, the present invention is a greening system for growing plants comprising
a soil layer for planting plants,
a permeable soil layer supporting portion that supports the soil layer, and
a water container portion that supports the soil layer and the soil layer supporting portion and is provided with a water storage portion and an air layer above the water storage portion, in which
the water container portion is configured to have the water storage portion by forming a container unit into an approximately rectangular shape in the top surface view and mating the sides of the adjacent container units;
the container unit has at least two container-shaped portions that can each be a water container connected to each other; and
the container unit has, at each predetermined position, an overflow portion through which water can overflow into the adjacent container-shaped portion, into the adjacent container unit, and to the outside of the container unit, respectively. Therefore, installing such a greening system that is easy to construct the container unit and excellent in waterproof properties, water retention ability, heat-insulating properties, and load bearing on rooftops and in parks has an effect of achieving greening with a very simple process as a whole. By increasing or decreasing the number of the container units, the greening system can flexibly respond to the shape of the installation surface of the greening system and also facilitates installation since there is no need to install a large container to accommodate individual water containers. Since the container unit is provided with the overflow portions at each predetermined position through which water can overflow into the adjacent container-shaped portion and to the outside of the container unit, the amount of water retained in the water storage portion can be kept constant and excess water can be drained out of the water storage portion.

The container unit is preferably provided with a reinforced portion, at a predetermined position, that connects adjacent container-shaped portions, e.g., side walls, thus improving load bearing.

The container unit is preferably mountain-folded on two outer sides and valley-folded on the other two sides, whereby the container unit can be mated each other at the mountain-folded and valley-folded portions to easily construct a greening system.

It is preferable that the container unit be configured to have a groove at the top center of each of two of the four side walls forming the container shape that serves as an overflow portion, allowing water from all of the container-shaped portions in the container unit to overflow to the outside of the container unit, whereby both the area of the side walls supporting the load and the air layer by overflow of the water can be secured.

It is preferable that the overflow portion provided between adjacent container units be configured to have one groove-shaped projection per container unit and the groove-shaped projection be formed to mate to another overflow portion of another container unit, whereby water can overflow from one to another container unit and the load bearing strength at the location is secured.

It is preferable that the container unit be formed by injection-molding molten thermoplastic resin into a mold at high pressure, which can form a lightweight container unit easily and thus facilitate easy construction of the greening system.

It is preferable that the soil layer supporting portion be a resin net with a yield point strength of not less than 2000 N/m, whereby the load on the upper soil layer can be dispersed and transferred to the container unit, improving the load bearing capacity.

The greening system of the present invention is configured by:
mating the sides of the adjacent container units to each other to thus render the container unit the water storage portion,
forming the water container portion so as to have an air layer above the container unit corresponding to the overflow portion,
installing the soil layer supporting portion that is supported by the water container portion, and further
installing the soil layer that is supported by the soil layer support, which has an effect of performing greening with very simple work as a whole.

### BRIEF DESCRIPTION OF DRAWINGS

FIG. 1(a) is a partially-omitted cross-sectional view showing a vertical section of a greening system of one embodiment, and FIG. (b) is a partially-enlarged view of part A of FIG. (a).

FIG. 2 (a) is a plan view, FIG. 2(b) is a front view, and FIG. 2(c) is a right side view of a container unit that constitutes a water container portion of the greening system of the above embodiment.

FIG. 3 is a cross-sectional of the container unit viewed from the B-B line shown in FIG. 2(a).

FIG. 4 is a simplified plan view of the arrangement of container units in the water container portion of the greening system according to the above embodiment.

FIG. 5 shows the mating state between container units that constitute the water container portion of the greening system according to the above embodiment; FIG. 5(a) is a front view viewed from the C-C line in FIG. 4 and FIG. 5(b) is a cross-sectional view viewed from the D-D line in FIG. 4, showing the overflow portion between container units.

FIG. 6 is an enlarged schematic view of a longitudinal section of a container-shaped portion constituting a container unit according to the above embodiment.

FIG. 7 is a flow chart showing a method of installing a greening system according to the invention.

### DESCRIPTION OF EMBODIMENTS

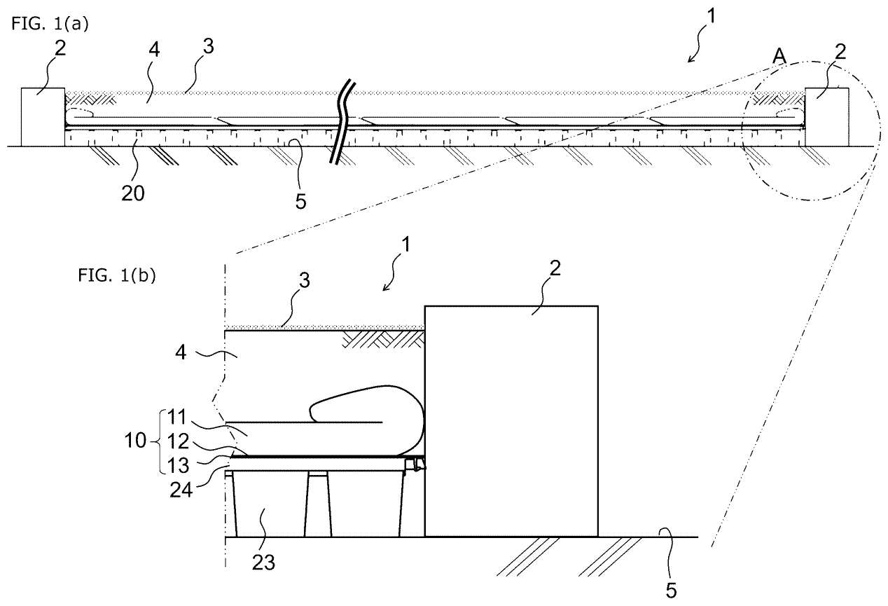

An embodiment of the present invention will be described based on the drawings. A greening system 1 of one embodiment according to the present invention shown in FIG. 1 includes an earth retainer 2 surrounding the outer periphery of an area to be greened, a soil layer 4 planted with turf 3 inside the earth retainer 2, a permeable soil layer supporting portion 10 that supports the soil layer 4, and a water container portion 20 that is arranged on an installation surface 5 inside the earth retainer 2 to support the soil layer 4 and the soil layer supporting portion 10. Instead of turf 3, grasses, flowers, shrubs, and medium-sized trees can be planted on the soil layer 4.

The earth retainer 2 can have a structure for holding the soil layer 4, for example, a concrete block such as a decorative block.

The soil layer 4 can use soil suitable for the plant to be planted, for example, system soil, which is soil with aeration and moisture retention properties adjusted to suit the plant to be planted. This allows plants to grow in a soil environment suitable for plant growth.

The soil layer supporting portion 10 can use permeable material that can support soil and can be comprised of, for example, a resin net 13, a root barrier permeable sheet 12, and high-performance charcoal such as recycled charcoal 11 piled thereon. Providing such a soil layer supporting portion 10 can prevent the soil from falling into a water container portion 20 to thus support the soil layer 4. It also becomes possible that water evaporated from a water storage portion 23 described below, which is provided in the water container portion 20, passes through the soil layer supporting portion 10 to supply the soil layer 4 with an appropriate amount of water, and that excess water is discharged from the soil layer 4 to the water storage portion 23 during rain or watering to maintain the soil layer 4 at an appropriate humidity level. In addition to the present embodiment, driftwood, demolished houses and other inexpensive materials can be used to construct the soil layer supporting portion 10 instead of the recycled charcoal 11. The root barrier permeable sheet 12 can be a polyester sheet or the like, which prevents plant roots from extending and reaching the water storage portion 23. This prevents water in the water storage portion from being sucked up by the plants, thereby enabling efficient water operation.

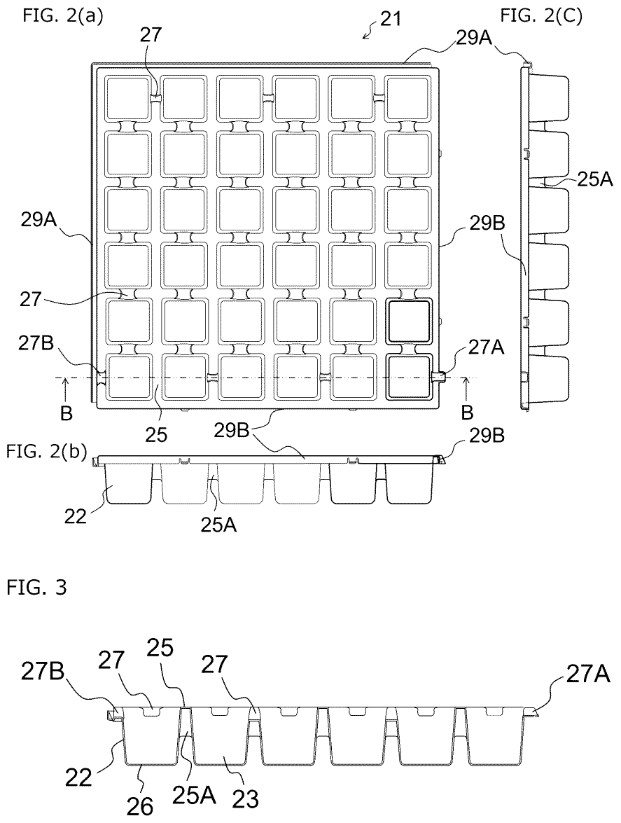

The water container portion 20 shown in FIG. 1 is configured by forming a container unit 21 as shown in FIGS. 2 to 6 into an approximately rectangular shape in the top surface view and fitting the sides of the adjacent container units. Container-shaped portions 22 of the container unit 21 constitute the water storage portion 23. This allows water to be stored in the water storage portion 23, allowing the humidity of the soil layer 4 to be properly maintained. Moreover, an air layer 24 above the container unit 21 formed at an overflow portion 27 of the water storage portion 23 has a heat-insulating effect, preventing heat death planted in the soil layer 4.

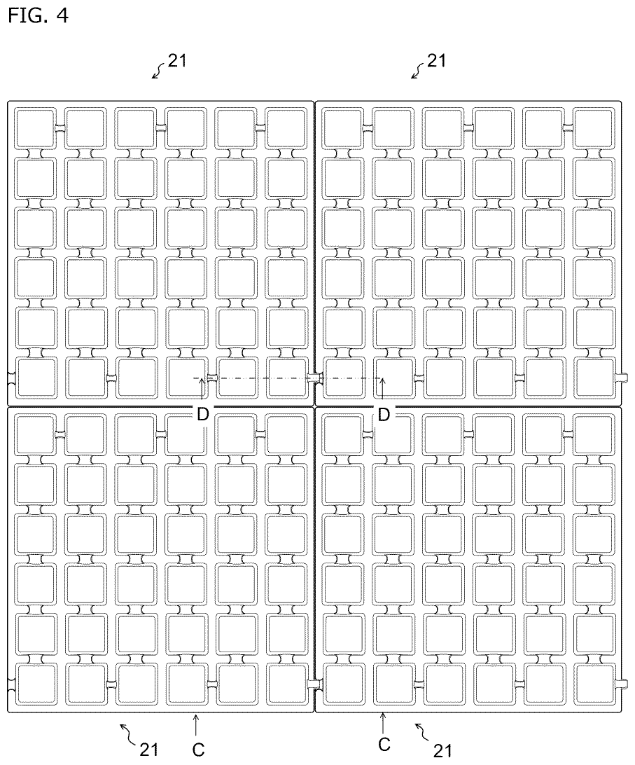

FIGS. 2 to 6 shows the container unit 21 used in this embodiment in details. FIG. 2 shows three views of the container unit 21, with FIG. 2(a), FIG. 2(b) and FIG. 2(c) representing a plan view, front view and right side view, respectively. FIG. 3 shows the B-B cross-sectional view shown in FIG. 2(a). FIG. 4 is a plan view showing a simplified arrangement of the container units 21 in the water container portion 20 of the greening system 1 of the embodiment.

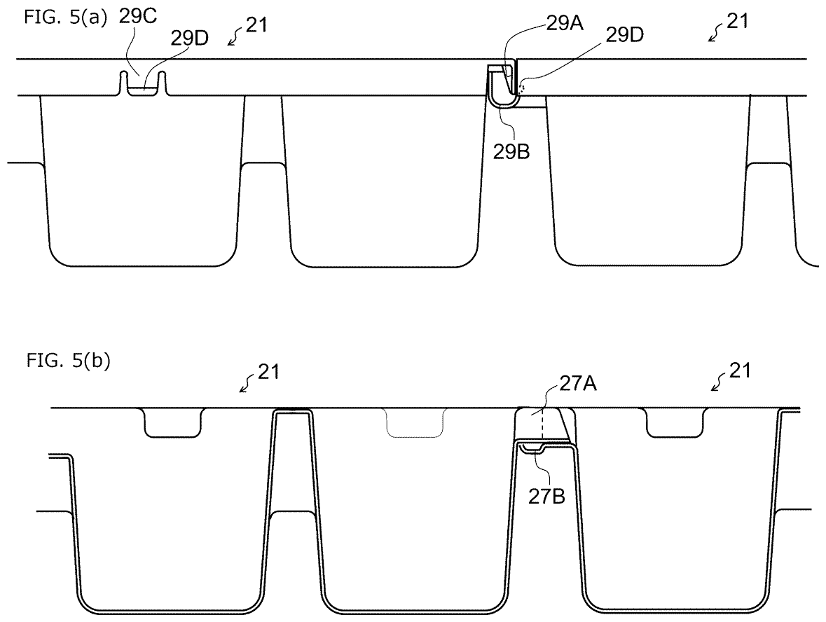

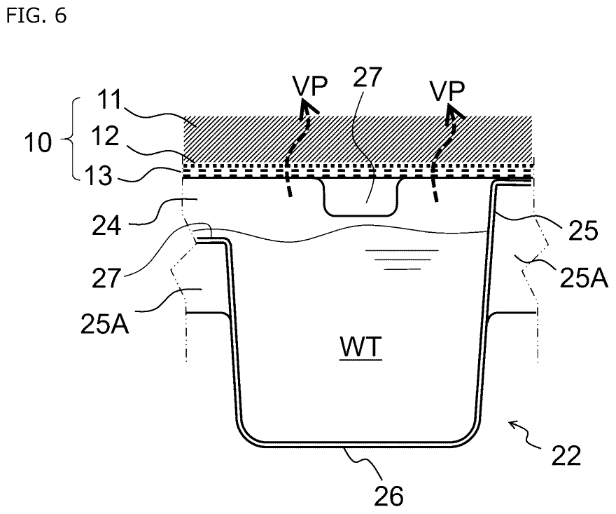

FIG. 5 shows a schematic diagram of the connecting state of the container units 21 shown in FIG. 4, with FIG. 5(a) representing a front view viewed from C-C, FIG. 5(b) representing a cross-sectional viewed from D-D. FIG. 6 is an enlarged schematic diagram of a longitudinal sectional view of the container-shaped portion 22 constituting the container unit 21 according to the above embodiment. The container unit 21 has at least two container-shaped portions 22, each of which is to be a water container, connected to each other, and as shown in FIGS. 2 and 3, each container-shaped portion 22 has, for example, a truncated rectangle pyramidal shape with a rectangular cross-section progressively getting smaller cross-sectional area towards the bottom.

The container unit 21 also has a groove, which serves as an overflow portion 27, in the center at the top of each of two of four side walls 25 forming each container-shaped portion 22 and is configured to allow water from all of the container-shaped portions 22 in the container unit 21 to overflow to the outside of the container unit 21. This configuration prevents the water level in the water storage portion 23 from rising above the groove that serves as the overflow portion 27 and keeps the amount of water retained in the water storage portion 23 constant, and thus excess water WT can be drained out of the water storage portion 23, forming a space (air layer 24) between the water surface and the resin net 13 (FIG. 6). Furthermore, increasing the number of container-shaped portions 22 with respect to the installation area of the greening system 1 can increase the amount of water retained when the greening system 1 is installed on a slope, compared to a single container of the same depth.

The container unit 21 can be made lightweight, for example, by injection-molding molten thermoplastic resin into a mold at high pressure, and can be made using other known materials and techniques. Recycled polypropylene can be also used.

It is preferable that the container units 1 are connected, for example, by mountain-folding two sides of the outer circumference of the container unit 1 formed into an approximately rectangular shape and valley-folding the other two sides, as shown in FIGS. 2, 4 and 5. By mating the mountain-folded part 29B to the valley-folded part 29A, a planar water container portion 20 can be easily constructed. In this embodiment, the mountain-fold part 29B is divided by a notch and has a fixed portion 29C with a hook 29D at the leading end. When the mountain-folded portion 29B is mated with the valley-folded portion 29A, the hook tip hooks into the hole in the valley-fold part corresponding to the hook 29D, providing a function of preventing falling out.

A sidewall reinforced portion 25A is installed to connect the sidewalls 25 of the adjacent container-shaped portions 22. A container bottom 26 is in close contact with the installation surface 5.

The load capacity of the container unit 1 is measured by evenly applying a vertical load to at least four container-shaped portions 22, each of which is almost rectangular in a plane view, arranged in two rows and two columns, and the load at which crushing flatly begins is defined as the load limit. For example, when the container-shaped portion 22 is a 70 mm×70 mm rectangle with a height of 70 mm in a planner view, the load should be placed evenly in the area of 200 mm×200 mm. To support soil and plantings for rooftop greening, the limit load should be not less than 5 kN/m². Considering emergency vehicle access, the limit load is desirably not less than 500 kN/m² with a resin sheet of appropriate strength laid on top. Increasing the load capacity needs a proper choice of material, an appropriate height and material thickness, and a proper choice of the shape. The groove constituting the overflow portion 27 cannot support load and thus should be few. Therefore, two of the four sides of the side wall 25 constituting the approximately rectangular container-shaped portion 22 should be provided with grooves, while the other two sides should be configured as load-bearing side walls 25 without grooves. The resin net 13 should have a yield point strength of not less than 2000 N/m yield point in both the longitudinal and lateral directions, preferably, the yield point strength is not less than 2700 N/m.

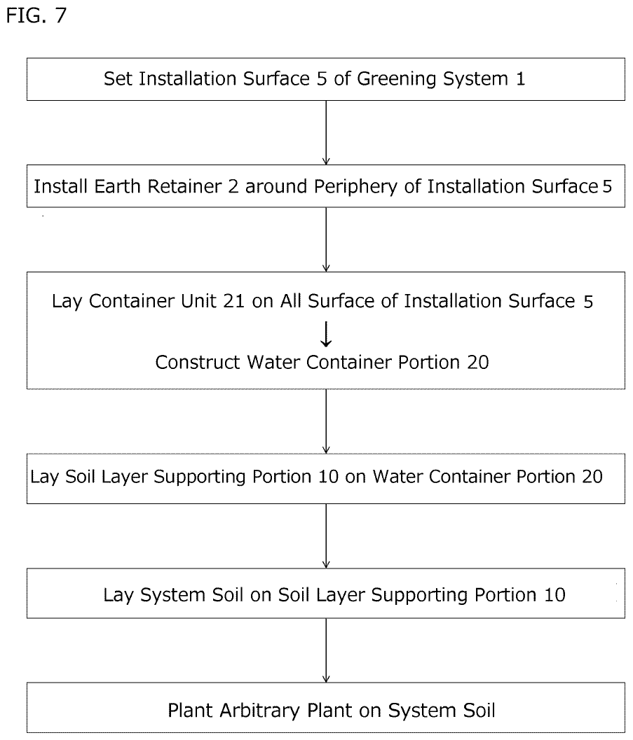

Next, a method of installing a greening system of another embodiment according to the invention will be described, based on the flow diagram shown in FIG. 7. The method for installing a greening system of the embodiment uses the container unit described above. The installation can be carried out in the following steps. First, the targeted installation surface 5 of the greening system 1 is set (S1). Concrete blocks as earth retainer 2 are installed around the periphery of that installation surface 5 (S2). The container units 21 are then laid on the installation surface 5, which is surrounded by concrete blocks. The container units 21 are mated to each other and laid to cover the installation surface without gaps to form the water container portion 20 (S3). The peripheral edges of the container units should be adapted to the shape of the installation surface by, for example, notching. On top of the water container portion 20 thus constructed, a resin net 13, root barrier permeable sheet 12 and recycled charcoal 11 are laid in sequence to construct the soil layer supporting portion 10 (S4). The system soil is then laid on top of the soil layer supporting portion 10 (S5), and any plants are planted in the system soil (S6).

Thus, a greening system 1 with excellent waterproofing, water retention, heat insulation, and load bearing properties can be provided, and by adjusting the number of the container units 21, the system is easily installed to suit the shape of the installation surface 5. In addition, as the container units 21 of the same shape are used, costs can be reduced through mass production.

The above description has been made on the embodiments of the greening system of the present invention with reference to the drawings. However, the invention is not limited to the above embodiment, and the material and production method of the constituent parts, the number of container-shaped portions and the arrangement of container units can be replaced by other parts and production methods in accordance with technical common sense.

For example, the shape of the container-shaped portion 22 of the container unit 21 can take various shapes, such as a truncated cone, a cylinder of varying thickness, a hemisphere, etc. By forming the overflow portion 27, which is the connecting part of the container-shaped portions 22, into a three-dimensional shape, such as a groove-shaped bridge, the bending resistance of the container unit 21 can be improved. Furthermore, the connection between container units is not limited to mountain-fold and valley-fold mating, and can have a configuration to have sufficient connection strength.

When a wall surface extending to the soil layer 4 is integrally formed on the container unit 21, which constitutes the outer circumference of the water container portion 20, the soil can be held only by the container unit 21, without the need for a separate soil retainer 2.

### REFERENCE SIGNS LIST

1 greening system
2 earth retainer
3 turf
4 soil layer
5 installation surface
10 soil layer supporting portion
11 recycled charcoal
12 root barrier permeable sheet
13 a resin net
20 water container portion
21 container unit
22 container-shaped portion
23 water storage portion
24 air layer
25 side wall
25A sidewall reinforced portion
26 bottom surface of container unit
27 overflow portion
27A overflow portion between container units (projection portion)
27B overflow portion between container units (receiving portion)
28 adjacent portion
29A valley-folded portion of container unit
29B mountain-folded portion of container unit
29C fixed portion
29D hook
VP vapor
WT water

1. A greening system for growing plants comprising
a soil layer for planting plants,
a permeable soil layer supporting portion that supports the soil layer, and
planar water container portion that supports the soil layer and the soil layer supporting portion and is provided with a water storage portion and an air layer above the water storage portion,
wherein
the water container portion is configured to have the water storage portion by forming a container unit into an approximately rectangular shape in the top surface view and mating the sides of the adjacent container units so as to have the water storage portion;
the container unit has at least two container-shaped portions connected to each other that can each be a water container and are arranged without overlapping each other; and the container unit has, at each predetermined position, an overflow portion through which water can overflow into the adjacent container-shaped portion, into the adjacent container unit, and to the outside of the container unit, respectively.

2. The greening system for growing plants according to claim 1, wherein
the container unit is provided with, at a predetermined position, a reinforced portion connecting the adjacent container-shaped portions.

3. The greening system for growing plants according to claim 1, wherein
the container unit is mountain-folded, i.e., folded into an inverted V shape on two outer sides and valley-folded, i.e., folded into a V shape on the other two sides, in which the mountain-folded sides are each divided by a notch and have a fixed portion with a hook at the leading end, while the valley-folded sides each have a hole for the hook to engage when the sides are mated.

4. The greening system for growing plants according to claim 1, wherein
the container unit is configured to have a groove at the top center of each of two of the four side walls forming the container-shaped portion that serves as an overflow portion, allowing water from all of the container-shaped portions in the container unit to overflow to the outside of the container unit.

5. The greening system for growing plants according to claim 1, wherein
the overflow portion provided between the adjacent container units has one groove-shaped projection formed per container unit so that the groove-shaped projection mates to another overflow portion of another container unit.

6. The greening system for growing plants according to claim 1, wherein
the container unit is formed by injection-molding molten thermoplastic resin into a mold at high pressure.

7. The greening system for growing plants according to claim 1, wherein
the soil layer supporting portion is a resin net with a yield point strength of not less than 2000 N/m.

8. A method of installing the greening system according to claim 1, wherein
the sides of the adjacent container units are mated to each other to render the container unit a water storage portion,
the water container portion is configured such that the upper part of the container unit corresponding to the overflow portion is to be an air layer, the soil layer supporting portion is arranged so as to be supported by the water container portion, and
the soil layer supported by the soil layer supporting portion is arranged.

9. The method of installing the greening system according to claim 8, wherein
the overflow portion provided between the adjacent container units has one groove-shaped projection per container unit so that the groove-shaped projection is arranged to mate to another overflow portion of another container unit.
